(19) United States
(12) Patent Application Publication
(10) Pub. No.: US 2001/0012352 A1
(43) Pub. Date: Aug. 9, 2001

(54) CALL MANAGEMENT SYSTEM AND METHOD USING THE REDIRECTING NUMBER FROM AN ISDN SETUP MESSAGE

(76) Inventor: JOHN T. MORGAN, NAVARRE, FL (US)

Correspondence Address: PETER LOFFLER, P O BOX 122, TALLAHASSEE, FL, 32302

(21) Appl. No.: 09/022,734

(22) Filed: Feb. 12, 1998

(51) Int. Cl. H04M 1/66; H04M 3/00

(52) U.S. Cl. 379/211.02; 379/265.02

(57) ABSTRACT

A method and system for managing incoming calls at a call center extracts the redirecting number from the incoming call's ISDN setup message and compares the redirecting number with a series of numbers within a stored database. Upon finding a match, the matched record is displayed on a display device and the call is handled by an operator in usual fashion with the operator having the displayed record available for personalized servicing of the incoming call.

### BACKGROUND OF THE INVENTION

1. Field of the Invention

The present invention relates to a call management system and method for use in a call center.

2. Background of the Prior Art

A typical call center may handle between 200 and 500 clients. In order to service these clients, the call center uses direct inward dialing (DID) trunks. In such an arrangement, each client is assigned a unique telephone number and forwards calls to this number to be serviced by the call center. Incoming calls are placed through the DID trunks to an available operator. This call center arrangement has several drawbacks.

The number of simultaneous calls that can be handled by the call center is limited by the number of trunks. If the call center has 8 trunks, the call center can only handle 8 simultaneous calls. If a 9th call comes in, the caller receives a central office busy signal. If additional call handling capacity is required, the call center must add additional trunks, which can be a very expensive undertaking both in equipment acquisition and maintenance costs. DID calls are incoming calls only. Therefore, if an incoming call needs to be patched, the call center will need to have regular business lines available. The call is patched over a business line and continues to tie up the trunk upon which the call came in. If the call center needs to add additional client capacity, then the call center must purchase additional telephone numbers from the phone company and must also reprogram its existing trunks to process the newly acquired numbers.

Establishing a call center using DID technology requires a substantial investment in switching equipment for the trunks and business lines. Expansion of an existing call center, either in client capacity or call capacity, requires additional investment of resources.

Therefore, there is a need in the art for a system and method for eliminating the problems associated with DID-based call center system.

### SUMMARY OF THE INVENTION

The call management system and method of the present invention addresses the aforementioned needs in the art. The system and method eliminate the DID trunks by using Integrated Services Digital Network (ISDN) technology. Specifically, the present invention utilizes one of the optional attachments of the ISDN setup message. This optional attachment, provided for under the ISDN specifications, is known as the redirecting number. The redirecting number is the telephone number from which the call to the call center was forwarded. If the call involves a series of forwarding sequences, then the setup message contains the first forwarding number and the last forwarding number—either of which can be used with the present invention.

All clients forward to the same call center number. A call comes into the call center as an appearance of the call center number. The present invention extracts the redirecting number from this incoming call and compares it against a database containing client information. When the redirecting number matches the key of a record, that record is extracted and presented to an operator on a display device. The elements of the record are used to identify the client and the operator can answer the call accordingly. If no match is found, the operator can answer the call blindly by asking for whom the call was placed, or in other desired fashion

The call management system and method of the present invention has many benefits over the old DID system. By using ISDN, the need for trunks and other switching equipment is eliminated as all switching is accomplished at the central office. The system uses the ISDN B-channel for voice handling of the calls and the D-channel for passing the setup messages, therefore, the operator has two-way interaction with each call. When a call is patched, the transfer occurs at the central office, freeing the operator's B-channel to handle other calls. When an operator is answering a call, an additional incoming call may appear on the operator's display device and the operator may act on this call as desired.

As all clients forward to the same number, upward expansion is relatively easy. The number of calls that a call center can receive on the call center number is limited by the number of call appearances to which the call center has subscribed. Therefore, in order to increase capacity, the call center need only to subscribe to additional call appearances on their single number (although certain switches assign a unique telephone number to each call appearance, this is not material to the clients of the call center). There is no physical limitations on the number of call appearances that can be subscribed to, although certain central office limitations and tariff considerations may place some upper limit on the number of call appearances on any given number.

### BRIEF DESCRIPTION OF THE DRAWINGS

FIG. 1 is a flow diagram illustrating the steps of the call management method.

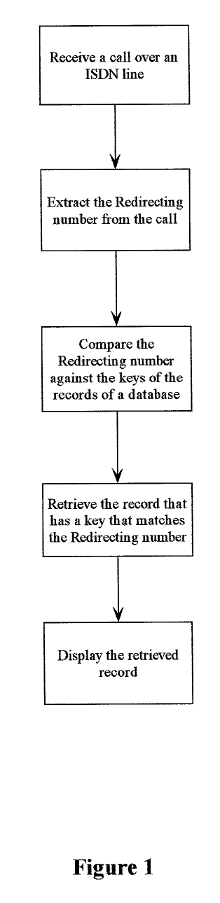

FIG. 2 is a block diagram representing the call management system within a telephone system.

FIG. 3 is a block diagram representing an implementation of the call management system within a call center.

Similar reference numerals refer to similar parts throughout the several views of the drawings.

### DESCRIPTION OF THE PREFERRED EMBODIMENT

Referring now to the drawings, it is seen that the call management system and method of the present invention comprise the receipt of an incoming call over an ISDN line. The redirecting number is extracted from the setup message of the call. The redirecting number can either be the first redirecting number or the last redirecting number if more than one redirecting number is present in the setup message. The redirecting number is used as a tag which is compared against the key of a series of records of a database. Once a key matches the tag, the record having the key is retrieved and certain elements of the record are displayed on a display device so that an operator can answer the call accordingly. The present invention can also extract the calling number from the setup message should the operator desire to take a message from the caller. The present invention can also extract the forwarded number of the call should the client desire such information. The present invention can also extract the forwarding reason (no answer forward, line busy forward, etc.,) of the call should the client desire such information.

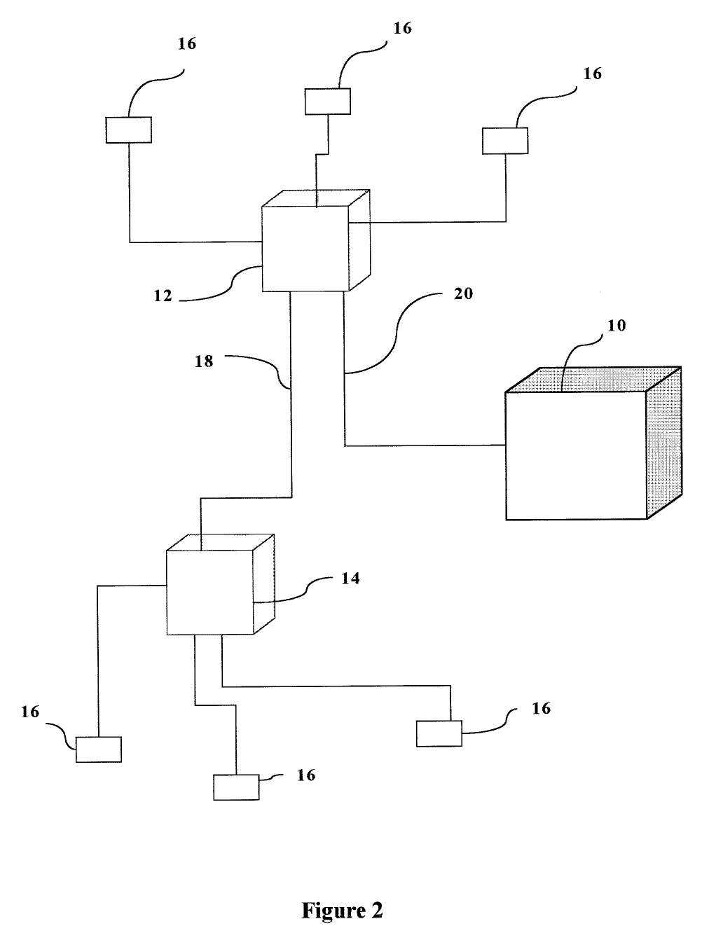

As seen in FIG. 2, the clients of the call center 10 subscribe to service with their particular central office. The central office may be the same central office 12 associated with the call center 10 or may be a remote central office 14. The clients 16 need not subscribe to ISDN service, however, the connections between any remote central office 14 and the call center's central office 12 must be capable of passing the redirecting number. This is typically provided if the data connection 18 between the central offices complies with the SS7 protocol for interoffice data links. If the client's central office 14 is incapable of passing the redirecting number, the client is given a remote call forward number—which itself forwards to the call center 10—at a central office that does pass the redirecting number and the client forwards to this remote call forward number when forwarding to the call center 10. Connections from the central office 12 to the call center 10 are achieved through at least one ISDN basic rate interface (BRI) circuit 20.

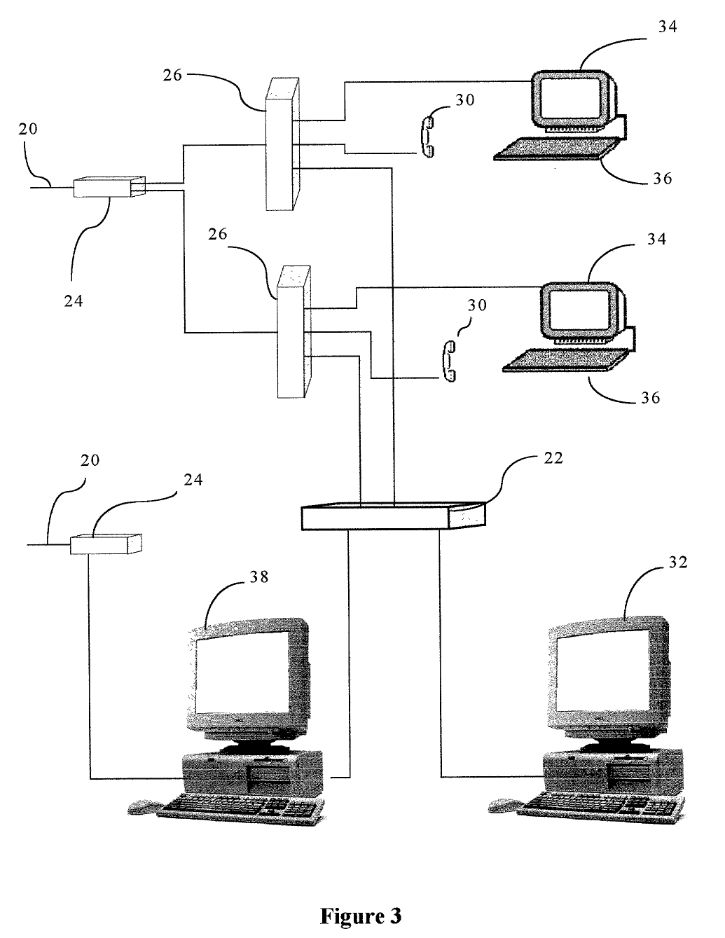

As seen in FIG. 3, a typical implementation of the system uses a computer network of any desired design, having a network hub 22, network terminators 24, and network node processors 26 or workstation 26, as needed (it being understood that a network of any design can be used within the scope and spirit of the present invention). As each ISDN BRI circuit 20 has one D-channel and two B-channels, up to two workstations are provided for each BRI circuit 20 coming into the call center 10. A talk set 30, such as a headset, handset, speaker phone, etc., is associated with each workstation for voice servicing of incoming calls. A database is present on the network. The database contains a plurality of records each having identifying keys. The database can be designed in any appropriate fashion and can contain any number and type of record elements as the call center owners desire. For example, if the call center 10 services a client that has four different telephone numbers that forward to the call center 10, the database can have four different records for that client, each record having one of the client's telephone numbers as its key. Alternately, one record can exist for the client with the record having multiple keys, one key for each of the client's telephone numbers. If desired, standard analog lines (not illustrated) can be attached to the network. These analog lines can be used for servicing call center 10 needs with such services as alpha paging, facsimile transmissions, etc. The analog lines are attached to the network through a computer 32. This computer 32, may also be but need not be, the supervisory computer for the network.

All clients of the call center 10 are assigned the same telephone number to use in order to forward to the call center 10. When a call is placed to a client 16 who has his calls forwarded to the call center 10, the call comes into the call center 10 containing various data concerning the call including the redirecting number. The data comes in on all of the BRI circuit's D-channel. The call comes in as a call appearance of the call center's telephone number on the D-channel. The system extracts the redirecting number and uses it as a tag and compares the tag against the keys of the records of the database. Once a match is found, certain elements of the matched record are retrieved and presented on the display device 34 of one of the workstations 26 as a call notification. The operator of that workstation 26 answers the call in appropriate fashion. If desired, the retrieved record can be updated by the operator with a message or other information via a keyboard 36 or other input device attached to the workstation 26. The voice path between the call is established on the BRI's B-channel assigned to that workstation 26. If the operator needs to patch the call to another number, the patch is performed across the D-channel with the switching occurring at the central office 12 and once completed, the operator's B-channel is again free to service other calls. If an operator is talking to a person on the B-channel, the D-channel is free to receive further call appearances and to present additional call notifications to the operator. The operator can place the call being serviced on hold and service the new call. The commands to switch between the calls are sent across the D-channel with the actual switching occurring at the central office 12. If the operator is servicing one call and receives a new call notification, the operator can chose not to answer this new call. In such a case, the call can be serviced by an auto-answer processor 38. This processor 38 can give an appropriate hold message and hold and queue the call until an operator becomes available. Alternately, the processor 38 can play a predefined message, either generic in fashion or client specific (with the particular client again being identified by the redirecting number), and if further desired can record a message from the calling party. Appropriate audio recording equipment is associated with this processor 38.

The number of call appearances that can be received at the call center 10 simultaneously, is restricted only by the number of call appearances to which the call center 10 has subscribed to. If a call comes into the call center 10, and the call center is currently servicing its maximum number of call appearances, then the new incoming call receives a central office 12 busy signal.

It is expressly recognized that other configurations of the call center 10 are possible within the scope and spirit of the present invention.

While the invention has been particularly shown and described with reference to an embodiment thereof, it will be appreciated by those skilled in the art that various changes in form and detail may be made without departing from the spirit and scope of the invention.

I claim:

1. A method of retrieving a single record from a database, the database having a plurality of records each with a unique key, the method comprising the steps of:
providing a ISDN compatible setup message;
extracting a tag from the setup message;
comparing the tag against the keys of the records;
retrieving the record having the key that matches the tag; and
displaying elements of the record.

2. The method as in claim 1 wherein the tag is a redirecting number.

3. The method as in claim 2 wherein the redirecting number is the first redirecting number within the setup message.

4. The method as in claim 2 wherein the redirecting number is the last redirecting number within the setup message.

5. The method as in claim 1 wherein the elements are displayed on a display device.

6. The method as in claim 1 further comprising the steps of:
extracting a redirecting reason from the setup message; and
displaying the redirecting reason.

7. The method as in claim 1 further comprising the steps of:
extracting a calling number from the setup message; and
displaying the calling number.

8. The method as in claim 1 further comprising the steps of:
extracting a forwarded number from the setup message; and
displaying the forwarded number.

9. A method of processing incoming calls at a call center from a central office and displaying a record from a database, each record having a plurality of elements including a unique key, the method of comprising the steps of:
sending a setup message having at last one tag, from the central office to the calling center;
extracting at least one of the at least one tag from the setup message;
comparing the extracted tag against the keys of the records;
retrieving the record having the key that matches the extracted tag; and
displaying at least some of the elements of the record.

10. The method as in claim 9 wherein the tag is a redirecting number.

11. The method as in claim 10 wherein the redirecting number is the first redirecting number within the setup message.

12. The method as in claim 10 wherein the redirecting number is the last redirecting number within the setup message.

13. The method as in claim 9 wherein the at least some elements are displayed on a video display terminal.

14. The method as in claim 9 further comprising the steps of:
extracting a redirecting reason from the setup message; and
displaying the redirecting reason.

15. The method as in claim 9 further comprising the steps of:
extracting a calling number from the setup message; and
displaying the calling number.

16. The method as in claim 9 further comprising the steps of:
extracting a forwarded number from the setup message; and
displaying the forwarded number.

17. A call management system capable of receiving incoming calls from a central office, each call having an ISDN compatible setup message, each message having at least one tag, the call management system comprising:
at least one workstation having a display device;
at least one talk set associated with each of the at least one workstation;
a database having a plurality of records, each record having a plurality of elements including a unique key; and
a processor capable of extracting at least one of the at least one tag from each of the incoming calls, comparing the extracted tag with the keys, extracting the record having the key that matches the tag and displaying at least some of the elements of the extracted record on the display device.

18. The call management system as in claim 17 further comprising means for providing a predetermined message to the incoming call whenever the incoming call is not answered.

19. The call management system as in claim 17 further comprising means coupled to each of the at least one workstation for servicing of the incoming call.

20. A call management system capable of receiving incoming calls from a central office, each call having an ISDN compatible setup message, each message having at least one tag, the call management system comprising:
at least one network;
a plurality of workstations, each having a display device, attached to the network;
at least one talk set associated with each of the plurality of workstations;
a database having a plurality of records, each record having a plurality of elements including a unique key attached to the network; and
at least one processor, for controlling the network and capable of receiving the incoming call and extracting at least one of the at least one tag from each of the incoming calls, comparing the extracted tag with the keys, extracting the record having the key that matches the tag and dispatching at least some of the elements of the extracted record to one of the plurality of workstations for display on the display device.

21. The call management system as in claim 20 further comprising means for providing a predetermined message to the incoming call whenever the incoming call is not answered.

22. The call management system as in claim 20 further comprising means coupled to each of the at least one workstation for servicing of the incoming call.

23. A call management system, in combination with a central office, the call management system capable of receiving incoming calls from the call center, each incoming call being ISDN compatible and having a setup message, each message having at least one tag, the call management system comprising:
at least one workstation having a display device;
at least one talk set associated with each of the at least one workstation;
a database having a plurality of records, each record having a plurality of elements including a unique key; and
at least one processor capable of extracting at least one of the at least one tag from each of the incoming calls, comparing the extracted tag with the keys, extracting the record having the key that matches the tag and displaying at least some of the elements of the extracted record on the display device.

24. The call management system as in claim 23 further comprising means for providing a predetermined message to the incoming call whenever the incoming call is not answered.

25. The call management system as in claim 23 further comprising means coupled to each of the at least one workstation for servicing of the incoming call.

26. A call management system capable of receiving incoming calls from a central office, each call having an ISDN compatible setup message, each message having at least one tag, the call management system comprising:
at least one workstation having a display device;
at least one talk set associated with each of the at least one workstation;
a database having a plurality of records, each record having a plurality of elements including a unique key; and
means for associating each of the incoming calls with one the plurality of records and displaying at least some the elements of the records on the display device.

27. The call management system as in claim 26 further comprising means for providing a predetermined message to the incoming call whenever the incoming call is not answered.

28. The call management system as in claim 26 further comprising means coupled to each of the at least one workstation for servicing of the incoming call.
